(19) United States
(12) Patent Application Publication
(10) Pub. No.: US 2021/0146340 A1
(43) Pub. Date: May 20, 2021

(54) Pt/CeO2-ZrO2 CATALYSTS FOR PASSIVE NOX ADSORPTION APPLICATIONS AND A METHOD OF MAKING THE CATALYST

(71) Applicant: Toyota Motor Engineering and Manufacturing North America, Inc., Erlanger, KY (US)

(72) Inventors: Krishna Gunugunuri, Canton, MI (US); Charles A. Roberts, Farmington Hills, MI (US); Torin C. Peck, Ann Arbor, MI (US)

(73) Assignee: Toyota Motor Engineering and Manufacturing North America, Inc., Erlanger, KY (US)

(21) Appl. No.: 16/688,720

(22) Filed: Nov. 19, 2019

(51) Int. Cl. B01J 23/63; B01D 53/94; B01J 37/03; B01J 37/02; B01J 37/08; F01N 3/08

(52) U.S. Cl. CPC B01J 23/63; B01D 53/9422; B01J 37/035; B01J 37/0236; B01J 37/08; F01N 3/0814; F01N 2570/14; B01D 2255/1021; B01D 2255/2065; B01D 2255/20715; B01D 2255/91; B01D 2255/407; F01N 3/0842

(57) ABSTRACT

Catalyst for passive NOx absorber to remove NOx from exhaust gas system during engine cold start operation having high storage capacity and ideal desorption properties. The catalyst may include a mixed oxide catalyst system having a Pt promoted Ce_{0.5}Zr_{0.5}O₂ catalyst material synthesized by co-precipitation using ammonium carbonate as a precipitation agent.

### TECHNICAL FIELD

The present disclosure generally relates to Pt promoted Ce_{0.5}Zr_{0.5}O₂ catalyst materials for passive NOx adsorption applications, a method of making the catalyst materials and a method of using the catalyst materials.

### BACKGROUND

The background description provided herein is for the purpose of generally presenting the context of the disclosure. Work of the presently named inventors, to the extent it may be described in this background section, as well as aspects of the description that may not otherwise qualify as prior art at the time of filing, are neither expressly nor impliedly admitted as prior art against the present technology.

The control of NOx emissions from lean-burn engines represents an on-going challenge to the automotive industry, particularly at the low exhaust temperatures (e.g., room temperature to about 250° C.) associated with modern, fuel efficient engines. While the factors limiting low temperature NOx control by catalyst-based aftertreatment systems are well recognized, the performance of current catalyst formulations is insufficient at the low exhaust temperatures expected for the new engines under development. An attractive option which to date has been little explored is the use of a passive NOx adsorber (PNA) device during cold start operation. In this system, the PNA adsorbs NOx emitted from the engine during cold starts, and then releases the NOx at higher temperatures. Then the under-floor catalyst is sufficiently active to function efficiently. Hence, the development of an effective catalyst for NOx storage would eliminate the NOx during engine cold start operation. Pt or Pd promoted Ce—Zr oxide-based catalysts have been known candidates for NOx storage applications. In general, Ce—Zr mixed oxides were synthesized using a co-precipitation method using ammonium hydroxide as the precipitating agent. However, there have been no reports on the influence of the precipitating agent on the NOx storage properties of Ce—Zr oxides.

### SUMMARY

This section provides a general summary of the disclosure and is not a comprehensive disclosure of its full scope or all of its features.

The present disclosure relates to catalyst for passive NOx absorber to remove NOx from exhaust gas systems during engine cold start operations.

In one aspect, the present disclosure provides a mixed oxide catalyst system for passive NOx adsorption, comprising a Pt promoted Ce_{0.5}Zr_{0.5}O₂ catalyst material synthesized by co-precipitation using ammonium carbonate as the precipitation agent.

In another aspect, the present disclosure provides a method for making a Pt promoted Ce_{0.5}Zr_{0.5}O₇ catalyst material, comprising co-precipitation using ammonium carbonate as the precipitation agent.

In another aspect, the present disclosure provides a method for passive NOx adsorption comprising contacting a lean gas stream with a Pt promoted Ce_{0.5}Zr_{0.5}O₂ catalyst material synthesized by co-precipitation using ammonium carbonate as the precipitation agent.

### DRAWINGS

The present teachings will become more fully understood from the detailed description and the accompanying drawings wherein:

FIG. 1 illustrates NOx release profiles of the Pt/Ce—Zr oxides during temperature programmed desorption.

FIGS. 2(a) to 2(d) illustrate Ce 3d XPS profiles of the Ce—Zr oxides synthesized by different precipitating agents.

It should be noted that the figures set forth herein are intended to exemplify the general characteristics of the methods, algorithms, and devices among those of the present technology, for the purpose of the description of certain aspects. These figures may not precisely reflect the characteristics of any given aspect and are not necessarily intended to define or limit specific embodiments within the scope of this technology. Further, certain aspects may incorporate features from a combination of figures.

### DESCRIPTION

As used herein, the terms “absorb” and “adsorb” and any derivatives thereof have been used interchangeably, and the specification should be interpreted accordingly.

The present inventors have developed a Pt promoted catalyst for passive NOx adsorption to remove NOx from exhaust gas system during engine cold start operations. The catalyst has a general composition of Pt/Ce_{0.5}Zr_{0.5}O₂.

The catalyst comprising a Pt promoted Ce_{0.5}Zr_{0.5}O₂ catalyst material is synthesized by a co-precipitation method using different precipitating agents. For example, the required amounts of metal precursors may be dissolved separately in water and the resulting solutions mixed together. The precipitating agent, such as NH₄OH, NaOH, (NH₄)₂CO₃, and Na₂CO₃. may be separately dissolved in water and the resulting precipitating agent solution added to the metal nitrate solution in a dropwise fashion. The reactants may be stirred constantly until a desired pH, such as a pH of 9-13, particularly 9-10, is reached. The supernatant liquid may be decanted and filtered to obtain a precipitate. The precipitate may be dried, ground into a fine powder and then calcined.

Suitable metal precursors for cerium include, but are not limited to, cerium nitrate (Ce(NO₃)₃), ammonium cerium nitrate ((NH₄)₂Ce(NO₃)₃), cerium chloride (CeCl₃), and cerium sulphate (Ce(SO₄)₂). Suitable metal precursors for zirconium include, but are not limited to, zirconium oxynitrate (ZrO(NO₃)₂), zirconium chloride (ZrCl₄), and zirconium acetate (ZrAc). Calcining may be at a temperature of from about 500-1000° C. for about 2 to 50 hrs. at a ramp rate of about 1 to 20° C./min. In one embodiment, the catalyst is calcined at 600° C. for 3 hrs at a ramp rate of about 5° C./min.

To obtain the Pt/Ce_{0.5}Zr_{0.5}O₂ catalyst, Pt may be deposited on a Ce—Zr support by a wet impregnation method. For example, the Ce—Zr support may be mixed with water to make a support suspension. A platinum nitrate solution may be added to the support suspension and the mixture heated with stirring. The obtained powder may be dried and then calcined at a temperature, time and ramp rate to obtain a catalyst having the desired properties. For example, calcining may be at a temperature of from about 500-1000° C. for about 2 to 50 hrs. at a ramp rate of about 1 to 20° C./min.

Surprisingly, the Pt promoted Ce—Zr support synthesized using ammonium carbonate as the precipitating agent of the present invention exhibits 1.5 times higher NOx storage capacity compared to catalysts synthesized using traditional ammonium hydroxide as the precipitating agent. Also, changing the precipitating agent controls the NOx desorption properties of the catalyst.

### Examples

Various aspects of the present disclosure are further illustrated with respect to the following examples. It is to be understood that these examples are provided to illustrate specific embodiments of the present disclosure and should not be construed as limiting the scope of the present disclosure in or to any particular aspect.

Synthesis and Material Characterization

The Ce_{0.5}Zr_{0.5}O₂ catalysts were synthesized by using a co-precipitation method using four different precipitating agents namely NH₄OH, NaOH, (NH₄)₂CO₃, and Na₂CO₃. In a typical synthesis procedure, the required amounts of Ce(NO₃)₃ and ZrO(NO₃)₂ were dissolved separately in deionized water and mixed together. The precipitating agents were also dissolved in water to form a precipitating agent solution. The precipitating agent solution was slowly added to the metal nitrate solution in a dropwise manner. The pH of the solution was constantly monitored as the precipitating agent solution was added. The reactants were constantly stirred using a magnetic stirrer until a pH level of 9-10 was reached. The supernatant liquid was then decanted and filtered to obtain the precipitate. The precipitate was then dried overnight at 120° C. The acquired substance was then grinded into a fine powder. Finally, the catalysts were calcined at 600° C. (5° C./min ramp rate) for 3 hours.

In an example, 1 wt % Pt was deposited on a Ce—Zr support using a wet impregnation method. 1 μm of the Ce—Zr support was mixed with 50 mL of water. Then the required quantity of platinum nitrate solution was added to the support suspension. The mixture was heated to 80° C. with continuous stirring. The powder obtained was then dried in an oven at 120° C. for 12 h under air. Finally, the catalyst was calcined at 450° C. for 3 h with a 1° C. min⁻¹ ramp.

XPS measurements were performed using PHI 5000 Versa Probe II X-ray photoelectron spectrometer using an Al Kα source. Survey scans (with 187.85 eV pass energy at a scan step of 0.8 eV) and high resolution (O 1s), (Pd 3d) and (C 1s) scans (with 23.5 eV pass energy at a scan step of 0.1 eV) were performed. Charging of the catalyst samples was corrected by setting the binding energy of the adventitious carbon (C is) to 284.6 eV. The XPS analysis was performed at ambient temperature and at pressures typically on the order of 10⁻⁷ Torr. Prior to the analysis, the samples were outgassed under vacuum for 30 mins.

NOx storage experiments were performed in Netzsch thermogravimetric analyzer coupled with mass spectroscopy. Prior to storage the material was pretreated to 600° C. in the presence of CO₂ and O₂ (9% CO₂, 9% O₂ balance Ar) to remove the adsorbed impurities. After the pretreatment, the temperature is decreased to 100° C. in the presence of CO₂ and O₂, and the NOx storage was performed at 100° C. for 30 min using NO+CO₂+O₂ mixture (1500 ppm NO+9% CO₂+9% O₂ balance Ar). After NOx storage, the temperature was ramped from 100-600° C. in the presence of CO₂ and O₂ to desorb the NO.

Performance Evaluation

According to the present disclosure, Pt promoted Ce_{0.5}Zr_{0.5}O₂ catalysts were developed for passive NOx adsorption applications.

Based on performance testing discussed herein, the Pt/Ce_{0.5}Zr_{0.5}O₂ catalyst synthesized by the co-precipitation using an ammonium carbonate precipitating agent exhibits 1.5 times higher NOx storage capacity compared to the traditional ammonium hydroxide precipitating agent.

The Pt/Ce_{0.5}Zr_{0.5}O₇ catalyst also exhibits ideal NO desorption properties for practical applications.

Passive NOx adsorption experiments were performed at 100° C. over Pt promoted Ce_{0.5}Zr_{0.5}O₂ catalysts synthesized by different precipitating agents. The NOx storage capacity values of Pt promoted catalysts are presented in Table 1. Surprisingly, the precipitating agent has a significant influence on the NOx storage properties of the Pt/Ce—Zr mixed oxides. Each of the catalysts obtained from the four different precipitating agents exhibits different NOx storage capacity values. Among the various catalysts, Pt/Ce—Zr catalysts synthesized by the ammonium carbonate precipitating exhibits the highest NOx storage capacity. Remarkably, it exhibits 1.5 times higher NOx storage capacity compared to the conventional ammonium hydroxide precipitating agent synthesis.

TABLE 1
NOx storage capacity and % of NO desorbed after
200° C. values of Pt/Ce_{0.5}Zr_{0.5}O₂ catalysts
synthesized using different precipitating agents.

| | NOx storage capacity | % of NO desorbed after |
|---|---|---|
| Precipitating agent | (μmol/g) | 200° C. |
| NH₄OH | 71 | 91 |
| (NH₄)₂CO₃ | 101 | 92.5 |
| NaOH | 53 | 92 |
| Na₂CO₃ | 27 | 90.6 |

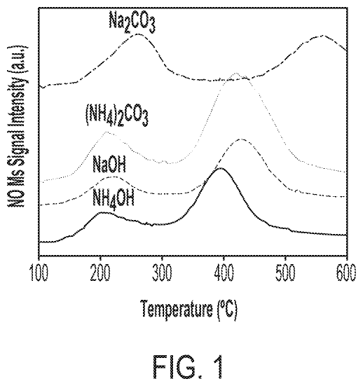

After NOx storage, the temperature was ramped from 100 to 600° C. in the presence of CO₂ and O₂ to release the stored NO. The NOx release profiles of the Pt/Ce—Zr oxides during temperature programmed desorption are presented in FIG. 1. For practical applications NOx should be released after 200° C. The percent (%) of NO desorbed during temperature programmed desorption are presented in Table 1. Interestingly, all the catalysts released more than 90% of NO at temperatures exceeding 200° C. Remarkably, the catalyst synthesized by the ammonium carbonate precipitating agent desorb (92.5%) higher NO after 200° C. compared to other precipitating agents. Additionally, the precipitating agent also has an influence on the NOx desorption properties of the Pt/Ce—Zr catalysts. These measurements show that the NOx desorption properties can be controlled by changing the precipitating agent during synthesis.

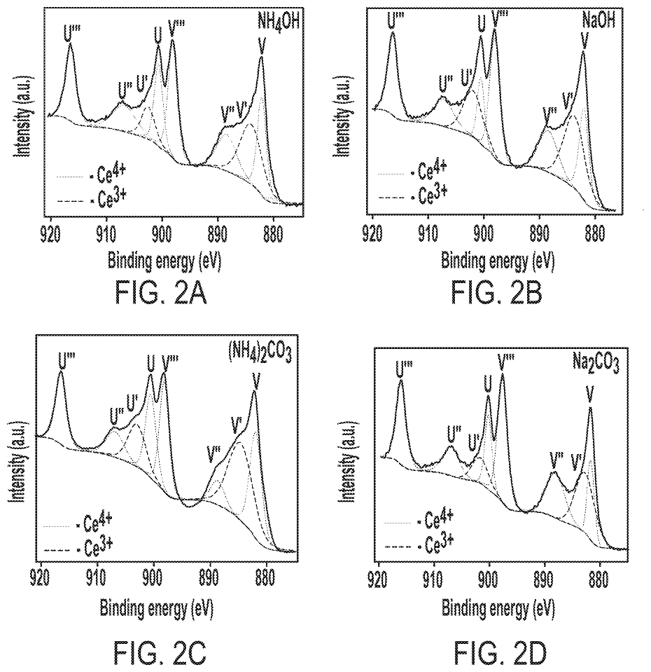

Referring to FIGS. 2(a) to 2(d), Ce 3d XPS profiles of the Ce—Zr mixed oxides synthesized by the different precipitating agents are presented. The XPS profiles show peaks labelled μ which are due to Ce3d_{3/2} spin orbit state and peaks labelled ν which are due to Ce3d_{5/2} spin orbit state. The peaks labeled μ′, μ″, μ and ν′″, ν″, and ν all are due to Ce⁴⁺ oxidation state only. In addition to the peaks due to the Ce′ oxidation state, all the catalysts also exhibit two additional peaks at 902.6 (μ′) and 884.8 eV (ν′). These peaks arise from 5/2 and 3/2 spin orbit states of Ce³⁺ oxidation state. These measurements show that incorporation of zirconium into the ceria lattice leads to cerium 4+ and 3+ oxidation states. Interestingly, all the Ce—Zr catalysts exhibit peaks due to both 4+ and 3+ oxidation states. It is difficult to calculate the amount of Ce³⁺ in the Ce—Zr catalysts since μ′ and ν′ peaks are surrounded by 4+ oxidation state peaks. However, the μ″ peak is not surrounded by any other peaks and the μ′″ peak belongs to 4+ oxidation state. Hence, area under the μ′ peak is used to calculate the amount of 3+ oxidation state in the Ce—Zr catalysts. In this regard, the lesser the area of the μ′″ peak, the higher the Ce³⁺ amount is in the catalyst.

The percent (%) of the p′″ peak area to the total area of Ce—Zr catalysts are presented in Table 2. Surprisingly, the catalyst synthesized by the ammonium carbonate precipitating agent exhibits the lowest % of the p′″ peaks while it has the highest Ce³⁺ amount compared to the other catalysts. It is well known that Ce⁴⁺/Ce³⁺ redox couple plays a major role during NOx storage in the passive NOx adsorption application. Pt/Ce—Zr catalyst synthesized by the ammonium carbonate exhibits higher Ce³⁺ amount and thereby higher NOx storage capacity.

TABLE 2
% of μ″′ peak area to the total area of Ce—Zr catalysts
synthesized by the different precipitating agents

| | % of μ″′ peak area to the |
|---|---|
| Precipitating agent | total area |
| NH₄OH | 12.3 |
| (NH₄)₂CO₃ | 10.8 |
| NaOH | 12.4 |
| Na₂CO₃ | 14.2 |

The preceding description is merely illustrative in nature and is in no way intended to limit the disclosure, its application, or uses. As used herein, the phrase at least one of A, B, and C should be construed to mean a logical (A or B or C), using a non-exclusive logical “or” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any aspect thereof. The recitation of multiple embodiments having stated features is not intended to exclude other embodiments having additional features, or other embodiments incorporating different combinations of the stated features.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

As used herein, the terms “comprise” and “include” and their variants are intended to be non-limiting, such that recitation of items in succession or a list is not to the exclusion of other like items that may also be useful in the devices and methods of this technology. Similarly; the terms “can” and “may” and their variants are intended to be non-limiting, such that recitation that an embodiment can or may comprise certain elements or features does not exclude other embodiments of the present technology that do not contain those elements or features.

The broad teachings of the present disclosure can be implemented in a variety f forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” or variations thereof) are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. A mixed oxide catalyst system for passive NOx adsorption, the mixed oxide catalyst system comprising a Pt promoted Ce_{0.5}Zr_{0.5}O₂ catalyst material synthesized by co-precipitation using ammonium carbonate as a precipitation agent.

2. The catalyst system according to claim 1, wherein the Pt promoted Ce_{0.5}Zr_{0.5}O₂ catalyst material has a high NOx storage capacity at a temperature in the range of from room temperature to about 250° C.

3. The catalyst system according to claim 2, wherein the temperature is about 100° C.

4. The catalyst system according to claim 1, wherein said catalyst exhibits 1.5 times higher NOx storage capacity compared to a catalyst synthesized using ammonium hydroxide as the precipitating agent.

5. A method for making a Pt promoted Ce_{0.5}Zr_{0.5}O₂ catalyst material by a coprecipitation method, said method comprising:
mixing a cerium precursor aqueous solution with a zirconium precursor aqueous solution;
adding (NH₄)₂CO₃ as a precipitating agent to obtain a precipitate;
drying the obtained precipitate; and
calcining the dried precipitate.

6. The method according to claim 5, wherein the cerium precursor is selected from the group consisting of cerium nitrate (Ce(NO₃)₃), ammonium cerium nitrate ((NH₄)₂Ce(NO₃)₃), cerium chloride (CeCl₃), and cerium sulphate (Ce(SO₄)₂).

7. The method according to claim 6, wherein the cerium precursor is cerium nitrate (Ce(NO₃)₃.

8. The method according to claim 5, wherein the zirconium precursor is selected from the group consisting of zirconium oxynitrate (ZrO(NO₃)₂), zirconium nitrate (Zr(NO₃)₄), zirconium chloride (ZrCl₄), and zirconium acetate (ZrAc).

9. The method according to claim 8, wherein the zirconium precursor is zirconium oxynitrate (ZrO(NO₃)₂).

10. method according to claim 5, wherein the calcining is conducted at a temperature of from about 500-1000° C., for about 2 to 50 hrs at a ramp rate of about 1 to 20° C./min.

11. The method according to claim 10, wherein the calcining is conducted at a temperature of about 600° C. for about 3 hours, and at a ramp rate of about 5° C./min ramp rate.

12. A method for passive NOx adsorption, the method comprising contacting a lean gas stream with a Pt promoted Ce_{0.5}Zr_{0.5}O₂ catalyst material synthesized by co-precipitation using ammonium carbonate as a precipitation agent.
